(19) United States
(12) Patent Application Publication
(10) Pub. No.: US 2016/0216589 A1
(43) Pub. Date: Jul. 28, 2016

(54) Imaging device

(71) Applicant: Zu Guang, Kowloon (HK)

(72) Inventor: Zu Guang, Kowloon (HK)

(21) Appl. No.: 14/603,377

(22) Filed: Jan. 23, 2015

(51) Int. Cl. G02F 1/163; H04N 5/232; G02F 1/1333; G02F 1/153; G02F 1/133

(52) U.S. Cl. CPC G02F 1/163; G02F 1/153; G02F 1/13318; G02F 1/133308; H04N 5/23245

(57) ABSTRACT

An imaging device contains: an image module, an optical switching module, and a light sensing control module. The optical switching module includes a base and an optical filter, the base has a bottom plate and a side plate, the bottom plate has an accommodating chamber, the side plate has a through hole communicating with the accommodating chamber, the optical filter has an electrochromic glass and an external wire, the electrochromic glass is electrically connected with the external wire, the light sensing control module includes a solar energy conversion unit and a control unit defined between the solar energy conversion unit and the external wire, the solar energy conversion unit transforms optical energy into electric energy, and the control unit controls an electrical connection between the solar energy conversion unit and the external wire based on the electric energy transformed from the solar energy conversion unit.

### FIELD OF THE INVENTION

The present invention relates to an imaging device which shoots images in different light intensities.

### BACKGROUND OF THE INVENTION

A conventional imaging device contains two glass pieces switched in a predetermined space by a movable optical switching module, but such a predetermined space increases a size of the movable optical switching module.

Furthermore, the movable optical switching module is aged after a period of using time, for example, the movable optical switching module cannot slide toward an aligning position accurately, so lens cannot align with the two glass pieces, thus switching an optical filtering inaccurately.

Also, the optical switching module is operated manually, and the imaging device causes high power consumption.

The present invention has arisen to mitigate and/or obviate the afore-described disadvantages.

### SUMMARY OF THE INVENTION

The primary object of the present invention is to provide an imaging device in which an optical switching module is switched to a pass filtering mode or an infrared filtering mode in different light intensities by using the electrochromic glass.

Another object of the present invention is to provide an imaging device in which a light sensing control module automatically senses the light intensities and controls the electrochromic glass to switch the optical switching module quickly.

An imaging device provided by the present invention contains: an image module, an optical switching module, and a light sensing control module. The optical switching module is located on the image module and includes a base and an optical filter.

The base has a bottom plate and a side plate formed on the bottom plate, the bottom plate has an accommodating chamber defined therein, the side plate has a through hole defined therein and communicating with the accommodating chamber, the optical filter is accommodated in the accommodating chamber of the bottom plate and has an electrochromic glass and an external wire, the electrochromic glass is disposed on one end of the through hole and is electrically connected with the external wire, the light sensing control module includes a solar energy conversion unit and a control unit defined between the solar energy conversion unit and the external wire of the optical filter, the solar energy conversion unit transforms optical energy into electric energy, and the control unit controls an electrical connection between the solar energy conversion unit and the external wire based on the electric energy transformed from the solar energy conversion unit.

### BRIEF DESCRIPTION OF THE DRAWINGS

FIG. 1 is a perspective view showing the exploded components of an imaging device according to a first embodiment of the present invention.

FIG. 2 is a plan view showing the assembly of an optical filter of the imaging device according to the first embodiment of the present invention.

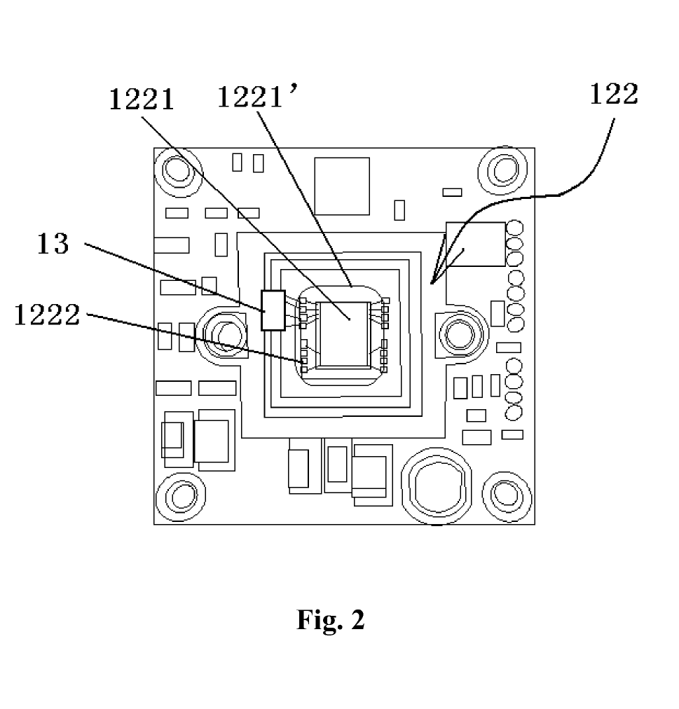

FIG. 3 is a perspective view showing the assembly of a base of the imaging device according to the first embodiment of the present invention.

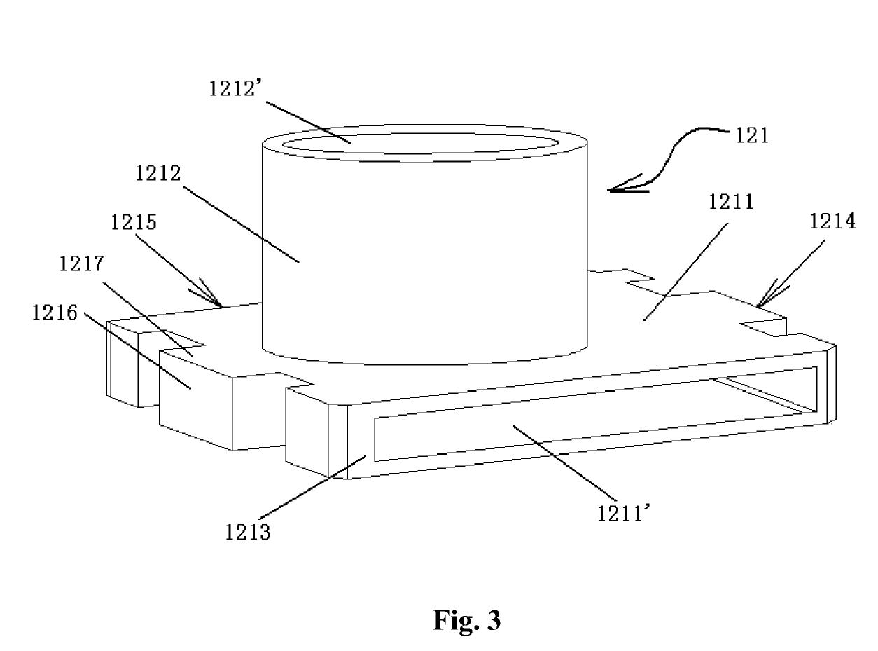

FIG. 4 is a diagram view showing a light sensing control module connecting with an external wire according to the first embodiment of the present invention.

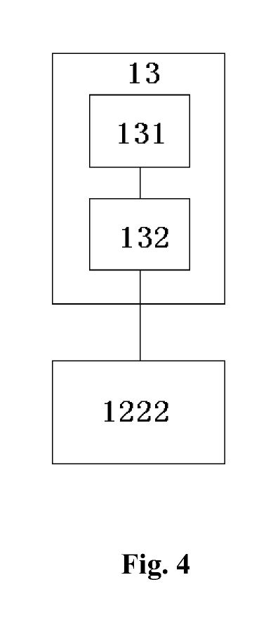

FIG. 5 is a diagram showing the assembly of an imaging device according to a second embodiment of the present invention.

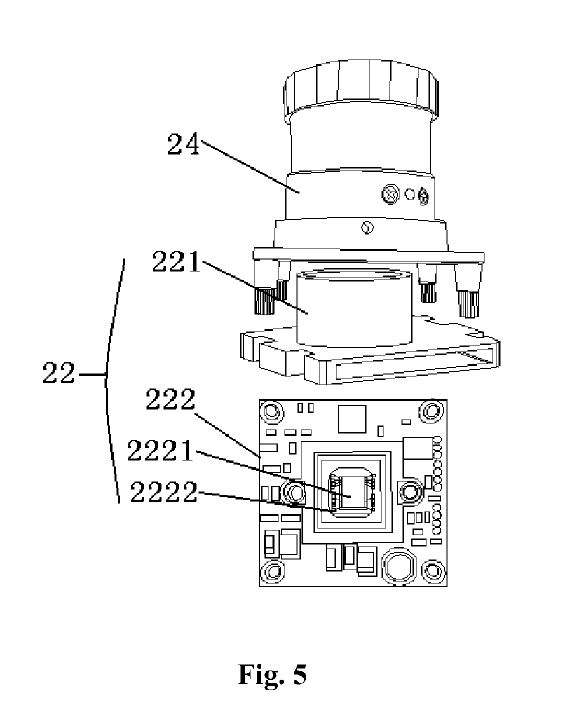

### DETAILED DESCRIPTION OF THE PREFERRED EMBODIMENTS

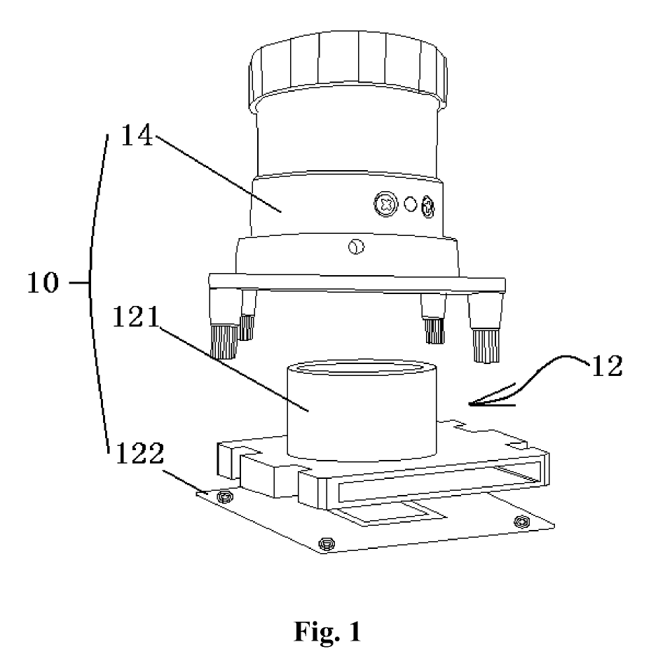

With reference to FIG. 1, an imaging device 10 according to a preferred embodiment of the present invention comprises: an image module, an optical switching module 12, and a light sensing control module 13. The optical switching module 12 is located on the image module, and the image module includes a lens assembly 14 above the optical switching module 12. The optical switching module 12 includes a base 121 and an optical filter 122, the base 121 has a bottom plate 1211 and a side plate 1212 formed on the bottom plate 1211, the bottom plate 1211 has an accommodating chamber 1211′ defined therein, the side plate 1212 has a through hole 1212′ defined therein and communicating with the accommodating chamber 1211′, the optical filter 122 is accommodated in the accommodating chamber 1211′ of the bottom plate 1211 and has an electrochromic glass 1221 and an external wire 1222, wherein the electrochromic glass 1221 is disposed on one end of the through hole 1212′ and is electrically connected with the external wire 1222. The light sensing control module 13 includes a solar energy conversion unit 131 and a control unit 132 defined between the solar energy conversion unit 131 and the external wire 1222 of the optical filter 122, wherein the solar energy conversion unit 131 transforms optical energy into electric energy, and the control unit 132 controls an electrical connection between the solar energy conversion unit 131 and the external wire 1222 based on the electric energy transformed from the solar energy conversion unit 131.

The solar energy conversion unit 131 has a silicon solar cell for absorbing and transforming solar energy into the electric energy, such that the solar energy conversion unit 131 supplies power to the optical filter 122. The control unit 132 has a power sensor for sensing pulse current of electric current generating from the solar energy conversion unit 131 to cause a close circuit/an open circuit of the external wire 1222. The control unit 132 sets a predetermined current value/voltage value in a light sufficient/insufficient condition, such that when the electric current/the voltage reaches the predetermined current value/voltage value, the control unit 132 controls the close circuit/the open circuit of the external wire 1222, and the external wire 1222 changes transmittancy of the electrochromic glass 1221.

The external wire 1222 is electrically connected with the electrochromic glass 1221, and the optical switching module 12 of the imaging device 10 is switched to a pass filtering mode or an infrared filtering mode in different light intensities by using the electrochromic glass 1221.

The bottom plate 1211 of the base 121 of the optical switching module 12 has a first side face 1213, a second side face 1214, a third side face 1215 opposite to the first side face 1213, and a fourth side face 1216 opposite to the second side face 1214. The accommodating chamber 1211′ is rectangular and extends through the first side face 1213 and the third side face 1215. The second side face 1214 and the fourth side face 1216 have two protrusions 1217 formed thereon and connecting with at least one joining portion of the optical filter 122 by ways of at least coupling element.

The electrochromic glass 1221 has a fixing frame 1221′ arranged around a peripheral side thereof, a transparent seat 1223, a first transparent conducting layer 1224, an electrochromic layer 1225, an electrolyte layer 1226, an ion storage layer 1227, a second transparent conducting layer 1224, and a protecting layer 1229 which are all packaged in the fixing frame 1221′, such that the transmittancy of the electrochromic glass 1221 is switched by using electrons.

The fixing frame 1221 is flexible and has a thickness greater than or equal to a height of the accommodating chamber 1211′. The fixing frame 1211′ aligns with the accommodating chamber 1211′, and lights transmit into the optical filter 122 from the through hole 1212′ via the accommodating chamber 1211′, wherein the fixing frame 1221′ fixes the electrochromic glass 1221 in the accommodating chamber 1211′.

A difference of an imaging device 20 of a second embodiment from that of the first embodiment comprises: an image module 21, an optical switching module 22, and a lens assembly 24 above the optical switching module 22. The optical switching module 22 includes a base 221 and an optical filter 222, and the optical filter 222 has an electrochromic glass 2221 and an external wire 2222 electrically connected with the electrochromic glass 2221, wherein a control switch controls a close circuit/an open circuit between the external wire 2222 and the electrochromic glass 2221 to start a change of the electrochromic glass 2221, and a power is supplied to the optical filter 122 from a cell.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An imaging device comprising:
an image module, an optical switching module, and a light sensing control module, the optical switching module being located on the image module and including a base and an optical filter, characterized in that:
the base has a bottom plate and a side plate formed on the bottom plate, the bottom plate has an accommodating chamber defined therein, the side plate has a through hole defined therein and communicating with the accommodating chamber, the optical filter is accommodated in the accommodating chamber of the bottom plate and has an electrochromic glass and an external wire, the electrochromic glass is disposed on one end of the through hole and is electrically connected with the external wire, the light sensing control module includes a solar energy conversion unit and a control unit defined between the solar energy conversion unit and the external wire of the optical filter, the solar energy conversion unit transforms optical energy into electric energy, and the control unit controls an electrical connection between the solar energy conversion unit and the external wire based on the electric energy transformed from the solar energy conversion unit.

2. An imaging device comprising:
an image module and an optical switching module, the optical switching module being located on the image module and including a base and an optical filter, characterized in that:
the base has a bottom plate and a side plate formed on the bottom plate, the bottom plate has an accommodating chamber defined therein, the side plate has a through hole defined therein and communicating with the accommodating chamber, the optical filter is accommodated in the accommodating chamber of the bottom plate and has an electrochromic glass and an external wire, the electrochromic glass is disposed on one end of the through hole and is electrically connected with the external wire.

3. The imaging device as claimed in claim 2 further comprising: a light sensing control module electrically connected with the optical filter.

4. The imaging device as claimed in claim 3, wherein the light sensing control module includes a solar energy conversion unit and a control unit defined between the solar energy conversion unit and the external wire of the optical filter, the solar energy conversion unit transforms optical energy into electric energy, and the control unit controls an electrical connection between the solar energy conversion unit and the external wire based on the electric energy transformed from the solar energy conversion unit.

5. An optical switching module of an imaging device comprising: a base and an optical filter, characterized in that:
the base has a bottom plate and a side plate formed on the bottom plate, the bottom plate has an accommodating chamber defined therein, the side plate has a through hole defined therein and communicating with the accommodating chamber, the optical filter is accommodated in the accommodating chamber of the bottom plate and has an electrochromic glass and an external wire, the electrochromic glass is disposed on one end of the through hole and is electrically connected with the external wire.

6. The optical switching module of the imaging device as claimed in claim 5, wherein the bottom plate of the base of the optical switching module has a first side face, a second side face, a third side face opposite to the first side face, and a fourth side face opposite to the second side face, the accommodating chamber is rectangular and extends through the first side face and the third side face.

7. The optical switching module of the imaging device as claimed in claim 6, wherein the electrochromic glass has a fixing frame arranged around a peripheral side thereof.

8. The optical switching module of the imaging device as claimed in claim 7, wherein the fixing frame is flexible and has a thickness greater than or equal to a height of the accommodating chamber.

9. The optical switching module of the imaging device as claimed in claim 6, wherein the second side face and the fourth side face have two protrusions formed thereon.

10. The optical switching module of the imaging device as claimed in claim 5, wherein the electrochromic glass also has a transparent seat, a first transparent conducting layer, an electrochromic layer, an electrolyte layer, an ion storage layer, a second transparent conducting layer, and a protecting layer which are all packaged in the fixing frame.
